(19) United States
(12) Patent Application Publication
(10) Pub. No.: US 2011/0140519 A1
(43) Pub. Date: Jun. 16, 2011

(54) POWER SUPPLY WITH REDUCED POWER CONSUMPTION AND COMPUTER HAVING SUCH POWER SUPPLY

(75) Inventors: Cheng-Yi Lo, Taoyuan Hsien (TW); Chen-Te Lin, Taoyuan Hsien (TW)

(73) Assignee: DELTA ELECTRONICS, INC., Taoyuan Hsien (TW)

(21) Appl. No.: 12/967,365

(22) Filed: Dec. 14, 2010

(30) Foreign Application Priority Data
Dec. 16, 2009 (TW) 098143153

(51) Int. Cl. H02J 4/00

(52) U.S. Cl. 307/24

(57) ABSTRACT

A power supply is used in a computer. The power supply includes a main power circuit, an auxiliary power circuit and a switching circuit. The main power circuit has a first main output terminal for outputting a first operating DC voltage. The auxiliary power circuit has an auxiliary output terminal connected to a standby circuit of the computer for outputting a standby DC voltage. The switching circuit is interconnected between the first main output terminal and the auxiliary output terminal. When the computer is in a power-off state, the switching circuit is shut off, and the standby circuit is powered by the standby DC voltage. When the computer is in a power-on state, the switching circuit is conducted, and the first operating DC voltage is transmitted to the standby circuit through the first main output terminal and the switching circuit so as to power the standby circuit.

### FIELD OF THE INVENTION

The present invention relates to a power supply, and more particularly to a power supply with reduced power consumption. The present invention also relates to a computer having such a power supply.

### BACKGROUND OF THE INVENTION

With increasing industrial development, diverse electronic appliances are used to achieve various purposes. An electronic appliance comprises a plurality of electronic components. Generally, different kinds of electronic components are operated by using different voltages.

As known, a power supply is essential for providing required DC voltages to many electronic components of a computer, for example including a hard disk, an optical disk drive, a motherboard, and the like. Generally, the conventional power supply has a main power circuit. For achieving high power converting efficiency, the power supply has resonant, push-pull, forward or buck circuitry architecture. When the computer is in a power-on state, the input power is converted into several regulated DC output voltages for powering the electronic components contained in the computer. For example, the common DC output voltages include 3.3, 5, 12 and −12 volts.

When the computer is in a power-off state, the power supply still needs to provide a standby DC voltage to certain low-power standby circuits such as the standby circuit of the motherboard. The standby DC voltage is employed to achieve some basic functions (e.g. power status indication) when the computer is powered off. The conventional power supply usually includes an auxiliary power circuit for converting the input voltage into the standby DC voltage (e.g. 5V). As such, the standby DC voltage is provided to the standby circuit when the computer is in the power-on state or the power-off state.

Since the auxiliary power circuit may only provide the standby DC voltage to certain low-power standby circuits of the computer, the auxiliary power circuit usually has relatively lower power converting efficiency. For example, the auxiliary power circuit is a flyback DC-to-DC converter, which is cost-effective.

Although the use of the flyback DC-to-DC converter as the auxiliary power circuit is cost-effective, there are still some drawbacks. For example, the operating DC voltage and the standby DC voltage are respectively provided by the main power circuit and the auxiliary power circuit. Since the auxiliary power circuit has lower power converting efficiency, the power supply still has high power consumption and fails to meet the power-saving requirement.

Therefore, there is a need of providing a power supply with reduced power consumption in order to obviate the drawbacks encountered from the prior art.

### SUMMARY OF THE INVENTION

The present invention provides a power supply with reduced power consumption and low cost.

The present invention also provides a computer system having such a power supply.

In accordance with an aspect of the present invention, there is provided a power supply for use in a computer. The power supply includes a main power circuit, an auxiliary power circuit and a switching circuit. The main power circuit has a first main output terminal for outputting a first operating DC voltage. The auxiliary power circuit has an auxiliary output terminal connected to a standby circuit of the computer for outputting a standby DC voltage. The switching circuit is interconnected between the first main output terminal and the auxiliary output terminal. When the computer is in a power-off state, the switching circuit is shut off, and the standby circuit is powered by the standby DC voltage. When the computer is in a power-on state, the switching circuit is conducted, and the first operating DC voltage is transmitted to the standby circuit through the first main output terminal and the switching circuit, thereby powering the standby circuit.

In accordance with another aspect of the present invention, there is provided a computer. The computer includes a standby circuit and the power supply of the present invention.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating a power supply for use in a computer according to an embodiment of the present invention; and

FIG. 2 is a schematic circuit block diagram illustrating a power supply for use in a computer according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

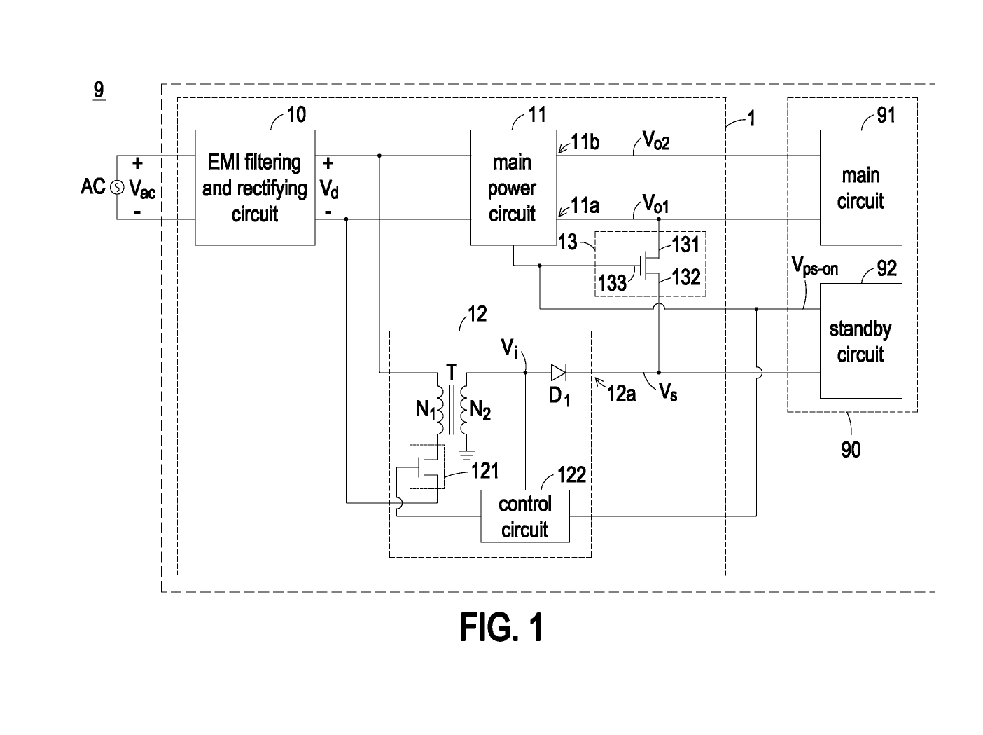

FIG. 1 is a schematic circuit block diagram illustrating a power supply for use in a computer according to an embodiment of the present invention. As shown in FIG. 1, the power supply 1 is included in a computer 9, and connected with a system unit 90 of the computer 9. An example of the computer 9 includes but is not limited to a personal computer. The computer 9 receives an AC voltage V_{ac} from a AC power source (e.g. utility power source). In this embodiment, the system unit 90 is a motherboard. The system unit 90 includes a main circuit 91 and a standby circuit 92. In a case that the computer 9 is in a power-on state, the main circuit 91 of the system unit 90 is enabled. Whereas, in a case that the computer 9 is in a power-off state, the standby circuit 92 of the system unit 90 is enabled. The standby circuit 92 may issue an operating-status signal Vₚₛ₋ₒₙ. When the computer 9 is in the power-off state, the operating-status signal Vₚₛ₋ₒₙ is at a low-level state. Whereas, when the computer 9 is in the power-on state, the operating-status signal Vₚₛ₋ₒₙ is at a high-level state.

Please refer to FIG. 1 again. The power supply 1 comprises an electromagnetic interference (EMI) filtering and rectifying circuit 10, a main power circuit 11, an auxiliary power circuit 12 and a switching circuit 13. The EMI filtering and rectifying circuit 10 is connected to the AC power source for receiving the AC voltage V_{ac}, filtering off noise contained in the AC voltage V_{ac}, and rectifying the AC voltage V_{ac} into a transition DC voltage V_{d}.

In this embodiment, the main power circuit 11 is a DC-to-DC converter. For achieving high power converting efficiency (e.g. about 90%), the main power circuit 11 is a resonant DC-to-DC converter, a push-pull DC-to-DC converter, a forward DC-to-DC converter or a buck DC-to-DC converter. The main power circuit 11 is interconnected between the EMI filtering and rectifying circuit 10 and the main circuit 91. The main power circuit 11 is also connected to the standby circuit 92 for receiving the operating-status signal Vₚₛ₋ₒₙ. The transition DC voltage V_{d} is received by the main power circuit 11. In a case that the operating-status signal Vₚₛ₋ₒₙ is at high-level state, the transition DC voltage V_{d} is converted into a first operating DC voltage Vₒ₁ and a second operating DC voltage Vₒ₂, which have different rated voltage values. The main power circuit 11 comprises a first main output terminal 11a and a second main output terminal 11b. The first operating DC voltage Vₒ₁ and the second operating DC voltage Vₒ₂ are outputted from the first main output terminal 11a and the second main output terminal 11b, respectively.

The auxiliary power circuit 12 is interconnected between the EMI filtering and rectifying circuit 10 and the standby circuit 92. In addition, the auxiliary power circuit 12 and the main power circuit 11 are connected with each other in parallel. The transition DC voltage V_{d} is converted into a standby DC voltage Vₛ having a rated voltage value by the auxiliary power circuit 12. The magnitude of the standby DC voltage Vₛ is substantially equal to the magnitude of the first operating DC voltage Vₒ₁. Moreover, the auxiliary power circuit 12 has an auxiliary output terminal 12a. The standby DC voltage Vₛ is outputted from the auxiliary output terminal 12a.

In this embodiment, the auxiliary power circuit 12 is a DC-to-DC converter having relatively lower power converting efficiency and cost than the main power circuit 11. For example, the auxiliary power circuit 12 is a flyback DC-to-DC converter having power converting efficiency of about 70%. As shown in FIG. 1, the auxiliary power circuit 12 comprises a transformer T, an auxiliary switching circuit 121, a control circuit 122 and a rectifier (e.g. a diode D₁).

The primary winding assembly N₁ of the transformer T is connected to the EMI filtering and rectifying circuit 10 and the auxiliary switching circuit 121. The secondary winding assembly N₂ of the transformer T is connected to the anode of the diode D₁. The auxiliary switching circuit 121 is selectively conducted or shut off. As such, the electric energy received by the primary winding assembly N₁ of the transformer T is magnetically transmitted to the secondary winding assembly N₂ of the transformer T. In this situation, the secondary winding assembly N₂ of the transformer T generates an internal voltage Vᵢ. The control circuit 122 is connected to a control terminal of the auxiliary switching circuit 121, the standby circuit 92 and the anode of the diode D₁. The control circuit 122 is used for controlling operations of the auxiliary switching circuit 121. According to the operating-status signal Vₚₛ₋ₒₙ issued from the standby circuit 92, the duty cycle of the control circuit 122 is controlled by the control circuit 122 and thus the magnitude of the internal voltage Vᵢ is adjusted. The cathode of the diode D₁ is connected to the auxiliary output terminal 12a.

The switching circuit 13 is interconnected between the first main output terminal 11a of the main power circuit 11 and the auxiliary output terminal 12a of the auxiliary power circuit 12. The switching circuit 13 has a first current-conducting terminal 131, a second current-conducting terminal 132 and a control terminal 133. The first current-conducting terminal 131 is connected to the first main output terminal 11a of the main power circuit 11. The second current-conducting terminal 132 is connected to the auxiliary output terminal 12a of the auxiliary power circuit 12. The control terminal 133 of the switching circuit 13 is connected to the standby circuit 92 and the main power circuit 11. According to the operating-status signal Vₚₛ₋ₒₙ issued from the standby circuit 92, the switching circuit 13 is selectively conducted or shut off.

An example of each of the auxiliary switching circuit 121 and the switching circuit 13 includes but is not limited to a metal oxide semiconductor field effect transistor (MOSFET) or a bipolar junction transistor (BJT). Alternatively, the auxiliary switching circuit 121 or the switching circuit 13 includes an electronic switch that is triggered to be conducted or shut off in response to a signal.

In an embodiment, each of the first operating DC voltage Vₒ₁ and the standby DC voltage Vₛ is 5V; and the second operating DC voltage Vₒ₂ is 3.3V, 12V or −12V. In the embodiment of FIG. 1, the main power circuit 11 has two main output terminals, and may output two operating DC voltages. It is noted that, however, those skilled in the art will readily observe that numerous modifications and alterations may be made while retaining the teachings of the invention. For example, in some embodiments, the main power circuit 11 has one main output terminal, and may output one operating DC voltage. Alternatively, the main power circuit 11 has more than three main output terminals, and may output more than three operating DC voltages.

Hereinafter, the operations of the power supply 1 will be illustrated in more details with reference to FIG. 1. In a case that the computer 9 is in a power-off state, the operating-status signal Vₚₛ₋ₒₙ issued from the standby circuit 92 is at a low-level state. In response to the operating-status signal Vₚₛ₋ₒₙ at the low-level state, the main power circuit 11 is disabled and the switching circuit 13 is shut off. At the same time, the standby DC voltage Vₛ is outputted from the auxiliary output terminal 12a of the auxiliary power circuit 12 to the standby circuit 92 for powering the standby circuit 92.

In a case that the computer 9 is switched from the power-off state to a power-on state, the operating-status signal Vₚₛ₋ₒₙ issued from the standby circuit 92 is switched from the low-level state to a high-level state. In response to the operating-status signal Vₚₛ₋ₒₙ at the high-level state, the main power circuit 11 is enabled and the switching circuit 13 is conducted. As a consequence, a first operating DC voltage Vₒ₁ and a second operating DC voltage Vₒ₂ are respectively outputted from the first main output terminal 11a and the second main output terminal 11b to the main circuit 91 for powering the main circuit 91.

In response to the operating-status signal Vₚₛ₋ₒₙ at the high-level state, the auxiliary switching circuit 121 is disabled or the duty cycle of the auxiliary switching circuit 121 is reduced under control of the control circuit 122. As such, the magnitude of the internal voltage Vᵢ is reduced to be lower than the rated voltage value. That is, the magnitude of the internal voltage Vᵢ is controlled to be lower than the standby DC voltage Vₛ. In this situation, the first diode D₁ is shut off and thus in an open-circuit state. The auxiliary power circuit 12 no longer offers electricity to the standby circuit 92. On the other hand, the first operating DC voltage Vₒ₁ is transmitted from the first main output terminal 11a of the main power circuit 11 to the standby circuit 92 through the switching circuit 13. In other words, the electric energy required for powering the standby circuit 92 is provided by the first operating DC voltage Vₒ₁.

In the above embodiment, the switching circuit 13 is interconnected between the main power circuit 11 and the auxiliary power circuit 12 and selectively conducted or shut off. In a case that the computer 9 is in a power-on state, the standby circuit 92 of the system unit 90 is powered by the main power circuit 11 with higher power converting efficiency. Whereas, in a case that the computer 9 is in a power-off state, the standby circuit 92 of the system unit 90 is powered by the auxiliary power circuit 12 with lower power converting efficiency. As a consequence, the power output efficiency of the power supply 1 is enhanced and the power consumption is reduced. Since the auxiliary power circuit 12 is more cost-effective, the fabricating cost of the power supply 1 is reduced.

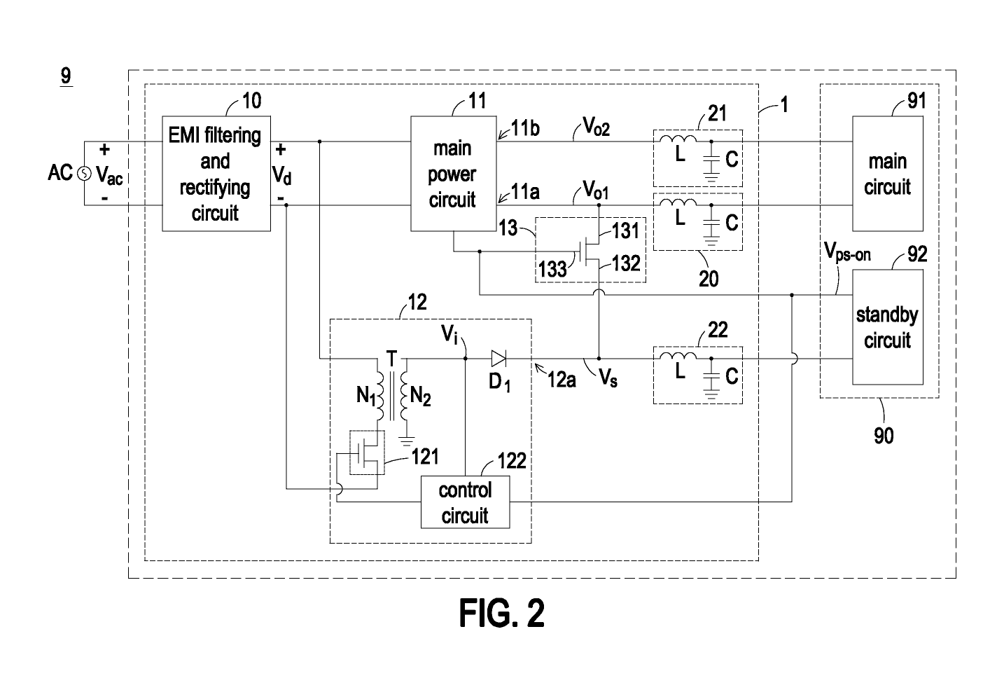

FIG. 2 is a schematic circuit block diagram illustrating a power supply for use in a computer according to another embodiment of the present invention. In comparison with FIG. 1, the power supply 1 of FIG. 2 further comprises a first filtering circuit 20, a second filtering circuit 21 and a third filtering circuit 22. The first filtering circuit 20 is interconnected between the first main output terminal 11a and the main circuit 91 for filtering the first operating DC voltage Vₒ₁. The second filtering circuit 21 is interconnected between the second main output terminal 11b and the main circuit 91 for filtering the second operating DC voltage Vₒ₂. The third filtering circuit 22 is interconnected between the auxiliary output terminal 12a and the standby circuit 92 for filtering the standby DC voltage Vₛ. Each of the first filtering circuit 20, the second filtering circuit 21 and the third filtering circuit 22 comprises at least one filter capacitor C and at least one filter inductor L.

From the above description, the present invention provides a power supply with reduced power consumption and a computer having the power supply. The switching circuit is interconnected between the main power circuit and the auxiliary power circuit. The switching circuit is controlled to be selectively conducted or shut off. In a case that the computer is in a power-on state, the standby circuit of the system unit is powered by the main power circuit with higher power converting efficiency, and the first operating DC voltage is transmitted to the standby circuit through the switching circuit. Whereas, in a case that the computer is in a power-off state, the standby circuit of the system unit is powered by the auxiliary power circuit with lower power converting efficiency, and standby DC voltage is provided to the standby circuit. As a consequence, the power output efficiency of the power supply is enhanced and the power consumption is reduced. In addition, since the auxiliary power circuit is more cost-effective, the fabricating cost of the power supply is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply for use in a computer, said power supply comprising:
a main power circuit having a first main output terminal for outputting a first operating DC voltage;
an auxiliary power circuit having an auxiliary output terminal connected to a standby circuit of said computer for outputting a standby DC voltage; and
a switching circuit interconnected between said first main output terminal and said auxiliary output terminal,
wherein when said computer is in a power-off state, said switching circuit is shut off, and said standby circuit is powered by said standby DC voltage, wherein when said computer is in a power-on state, said switching circuit is conducted, and said first operating DC voltage is transmitted to said standby circuit through said first main output terminal and said switching circuit, thereby powering said standby circuit.

2. The power supply according to claim 1 wherein said first main output terminal of said main power circuit is connected with a main circuit of said computer, wherein when said computer is in said power-on state, said first operating DC voltage is transmitted from said first main output terminal to said main circuit.

3. The power supply according to claim 2 wherein said main power circuit further comprises a second main output terminal, which is connected with said main circuit for outputting a second operating DC voltage.

4. The power supply according to claim 1 wherein said auxiliary power circuit has lower power converting efficiency than said main power circuit.

5. The power supply according to claim 1 wherein the magnitude of said first operating DC voltage is substantially equal to the magnitude of said standby DC voltage.

6. The power supply according to claim 1 further comprising an EMI filtering and rectifying circuit, which is connected to an AC power source, said main power circuit and said auxiliary power circuit for filtering off noise contained in an AC voltage provided by said AC power source and rectifying said AC voltage.

7. The power supply according to claim 1 wherein said standby circuit issues an operating-status signal, said operating-status signal is at a high-level state when said computer is in said power-on state, and said operating-status signal is at a low-level state when said computer is in said power-off state.

8. The power supply according to claim 7 wherein said switching circuit has a control terminal connected to said standby circuit for receiving said operating-status signal, and said switching circuit is conducted or shut off in response to said operating-status signal.

9. The power supply according to claim 7 wherein said auxiliary power circuit comprises:
a transformer;
a rectifier having a first end connected to said auxiliary output terminal and a second end connected to a secondary winding assembly of said transformer, and receiving an internal voltage from said transformer;
an auxiliary switching circuit connected to a primary winding assembly of said transformer; and
a controlling circuit connected to said auxiliary switching circuit, said secondary winding assembly of said transformer and said standby circuit, and receiving said operating-status signal,
wherein when said computer is in said power-on state and said operating-status signal is at a high-level state, said auxiliary switching circuit is shut off or a duty cycle of said auxiliary switching circuit is reduced under control of said control circuit, so that the magnitude of said internal voltage is controlled to be lower than said standby DC voltage and said rectifier is in an open-circuit state.

10. The power supply according to claim 9 wherein each of said switching circuit and said auxiliary switching circuit includes a metal oxide semiconductor field effect transistor.

11. The power supply according to claim 9 wherein said rectifier is a diode.

12. The power supply according to claim 1 wherein said main power circuit and said auxiliary power circuit are DC-to-DC converters.

13. The power supply according to claim 1 wherein said main power circuit is a resonant DC-to-DC converter, a push-pull DC-to-DC converter, a forward DC-to-DC converter or a buck DC-to-DC converter.

14. The power supply according to claim 1 wherein said auxiliary power circuit is a flyback DC-to-DC converter.

15. The power supply according to claim 1 further comprising:
a first filtering circuit connected with said first main output terminal for filtering said first operating DC voltage; and
a second filtering circuit connected with said auxiliary output terminal for filtering said standby DC voltage.

16. The power supply according to claim 15 wherein each of said first filtering circuit and said second filtering circuit includes at least one filter capacitor and at least one filter inductor.

17. The power supply according to claim 1 wherein each of said first operating DC voltage and said standby DC voltage is 5V.

18. A computer with reduced power consumption, said computer comprising:
a standby circuit; and
a power supply comprising:
a main power circuit having a first main output terminal for outputting a first operating DC voltage;
an auxiliary power circuit having an auxiliary output terminal connected to said standby circuit of said computer for outputting a standby DC voltage; and
a switching circuit interconnected between said first main output terminal and said auxiliary output terminal,
wherein when said computer is in a power-off state, said switching circuit is shut off, and said standby circuit is powered by said standby DC voltage, wherein when said computer is in a power-on state, said switching circuit is conducted, and said first operating DC voltage is transmitted to said standby circuit through said first main output terminal and said switching circuit so as to power said standby circuit.

19. The computer according to claim 18 wherein said computer further comprises a main circuit, wherein said main circuit is enabled when said computer is in said power-on state, and said standby circuit is enabled when said computer is in said power-off state.

20. The computer according to claim 19 wherein said computer is a personal computer, and said main circuit and said standby circuit are included in a motherboard of said computer.
